(19) United States
(12) Patent Application Publication
(10) Pub. No.: US 2008/0180015 A1
(43) Pub. Date: Jul. 31, 2008

(54) Heat-sink module of light-emitting diode

(75) Inventors: Ching-Huei Wu, San Chung City (TW); Yao-Jen Kang, San Chung City (TW)

Correspondence Address: TROXELL LAW OFFICE PLLC;SUITE 1404, 5205 LEESBURG PIKE, FALLS CHURCH, VA, 22041, US

(73) Assignee: Unity Opto Technology Co., Ltd.

(21) Appl. No.: 11/699,247

(22) Filed: Jan. 29, 2007

(51) Int. Cl. H01K 1/58

(52) U.S. Cl. 313/46

(57) ABSTRACT

A heat-sink module of light-emitting diode comprises a circuit board, at least a light-emitting diode, at least a heat-conducting layer, and a heat-sink block, wherein the circuit board has a through hole formed thereon, and the light-emitting diode is mounted across over the through hole of the circuit board. In addition, the heat-conducting layer is mounted under the light-emitting diode. The heat-sink block is coupled with the heat-conducting layer via the through hole of the circuit board. As a result, the heat-dissipating efficiency of the light-emitting diode can be improved.

### FIELD OF THE INVENTION

The present invention relates to a heat-sink module of light-emitting diode capable of increasing the heat-dissipating efficiency of the light-emitting diode, and more particularly to a heat-sink module applicable to a high brightness light-emitting diode, a super-high brightness light-emitting diode, or the like.

### BACKGROUND OF THE INVENTION

At present, the light-emitting diodes (LEDs) are gradually, widely applied to indicator lights and display devices of information, communication and consumer electronic products such as display panels of liquid crystal TVs, mobile phones, personal digital assistants (PDAs), and global positioning systems (GPSs) and illumination. Accordingly, the input power of the LED chips must be increased progressively. However, the accumulated heat energy reduces the lighting efficiency and heats up the LEDs. The stress formed by the raised temperature makes the LED structures poor and damaged. As a result, the manufacturers of mobile phones or super-high brightness LEDs are confronted by the problems of heat dissipation. Moreover, the problems of qualitative changes and lifetime decrease are very critical for the high or super-high brightness LEDs.

Referring to FIG. 4, in a conventional heat-sink module of light-emitting diode, a heat-conducting layer 4 is attached under the light-emitting diode 1, and a circuit board 2 is attached under the heat-conducting layer 4. In addition, an aluminum plate 3 is adhered to the circuit board 2. A heat-sink block 5 is attached under the aluminum plate 3 so as to speed up heat dissipation.

When the heat-sink module is applied to the light-emitting diode, the heat is first conducted to the circuit board 2, and the heat is then conducted to the heat-sink block 5 via the circuit board 2 and the aluminum plate 3. However, the circuit board 2 is made of a material unfavorable to heat dissipation, causing the significant reduction of heat dissipation speed.

In view of the foregoing description, the motive of the present invention is to provide the general public with a heat-sink module of light-emitting diode capable of increasing the heat-dissipating efficiency of the light-emitting diode.

### SUMMARY OF THE INVENTION

It is a main object of the present invention to provide a heat-sink module of light-emitting diode capable of increasing the heat-dissipating efficiency of the light-emitting diode.

In order to achieve the above-mentioned objects, a heat-sink module of light-emitting diode is comprised of a circuit board, at least a light-emitting diode, at least a heat-conducting layer, and a heat-sink block, wherein the circuit board has a through hole formed thereon, and the light-emitting diode is mounted across over the through hole of the circuit board. In addition, the heat-conducting layer is mounted under the light-emitting diode. The heat-sink block is coupled with the heat-conducting layer via the through hole of the circuit board. As a result, the heat-dissipating efficiency of the light-emitting diode can be increased.

The aforementioned objects and advantages of the present invention will be readily clarified in the description of the preferred embodiments and the enclosed drawings of the present invention.

### BRIEF DESCRIPTION OF THE DRAWINGS

FIG. 1 is an elevational diagram of a preferred embodiment of the present invention.

FIG. 2 is a decomposed diagram of the preferred embodiment of the present invention.

FIG. 3 is a schematic sectional view showing the assembled structure in accordance with the preferred embodiment of the present invention.

FIG. 4 is a schematic sectional view showing the assembled structure of a conventional heat-sink module of light-emitting diode.

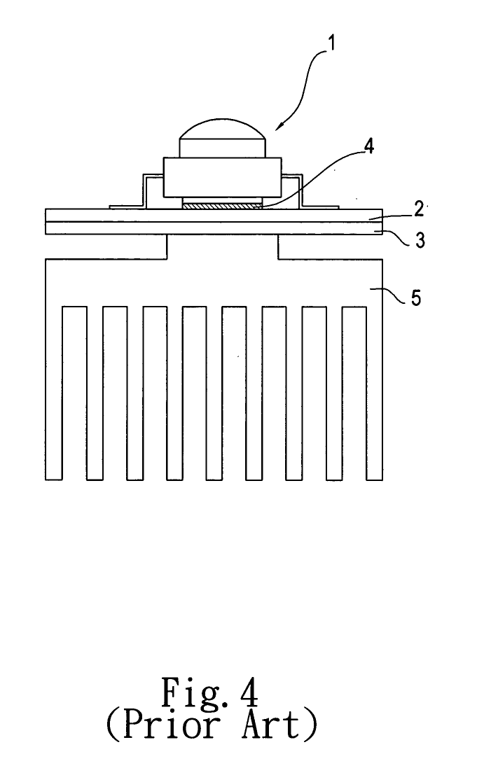

### DETAILED DESCRIPTION OF THE PREFERRED EMBODIMENT

The objects, features, advantages, and benefits of the invention will become apparent in the following description taken in conjunction with the foregoing drawings.

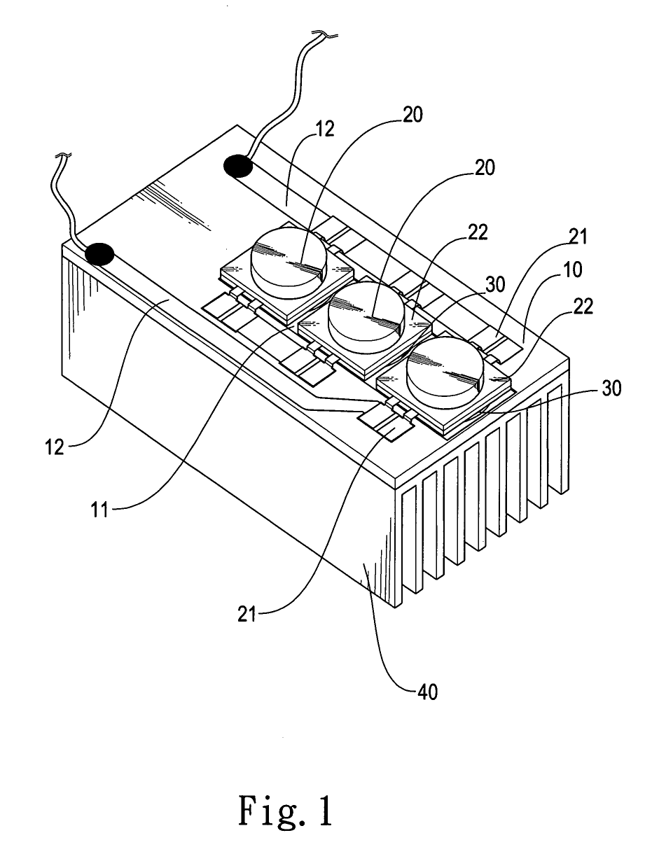

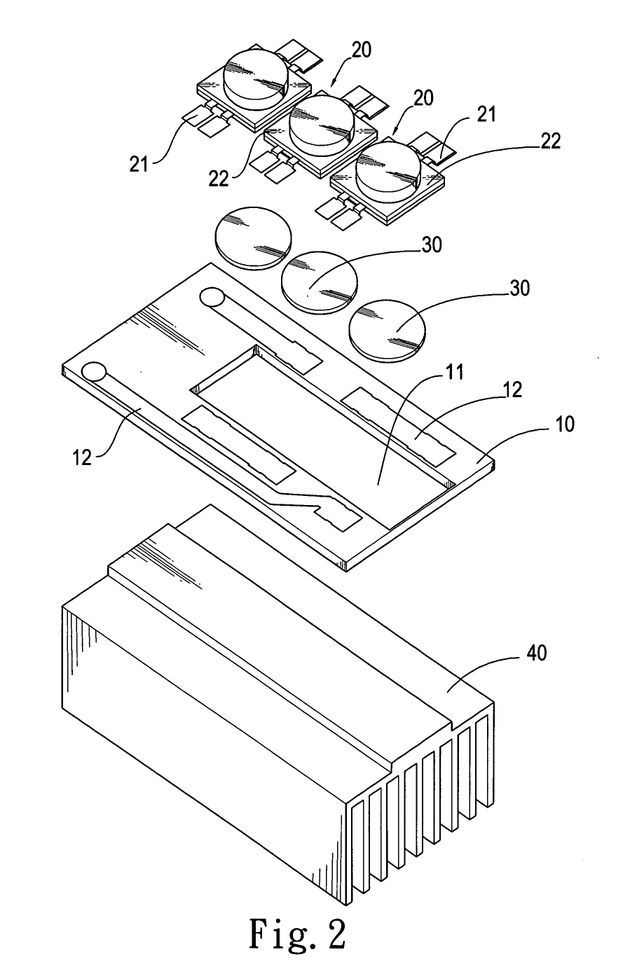

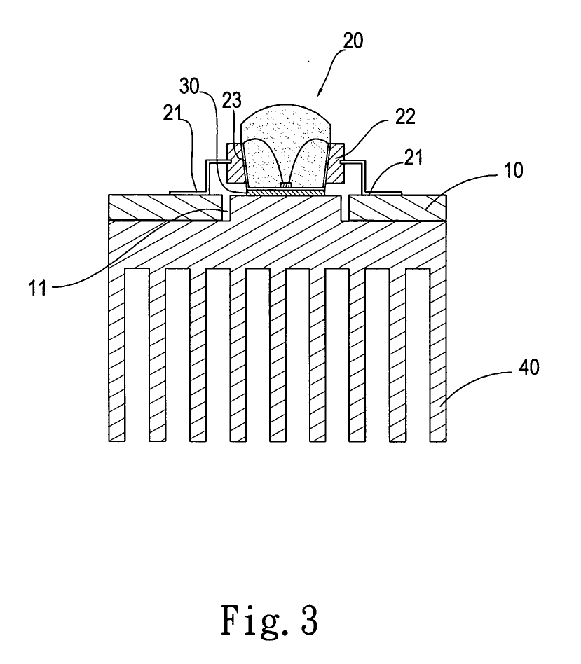

Referring to FIG. 1 through FIG. 3, a heat-sink module of light-emitting diode of the present invention comprises a circuit board 10, at least a light-emitting diode 20, at least a heat-conducting layer 30, and a heat-sink block 40, wherein the circuit board 10 has a through hole 11 formed thereon. In addition, several connection circuits 12 are formed on the circuit board 10 around the through hole 11. The light-emitting diode 20 is mounted on the circuit board 10 across over the through hole 11. The light-emitting diode 20 has a coupling base 22 and several frames 21. The heat-conducting layer 30 has a shape corresponding to that of the through hole 11 of the circuit board 10 or the coupling base 22 of the light-emitting diode 20. In this preferred embodiment, the heat-conducting layer 30 has a circular shape according to the shape of the coupling base 22 of the light-emitting diode 20. In addition, the heat-sink block 40 that has several heat-sink fins formed thereon is mounted underneath the heat-conducting layer 30. In practice, other type of heat-sink block 40 is also adoptable.

If it is applied to a high brightness light-emitting diode 20, the frames 21 of the light-emitting diode 20 must be welded to the connection circuits 12 of the circuit board 10. In this preferred embodiment, three light-emitting diodes 20 are utilized, and electrically arranged according to the connection circuits 12 of the circuit board 10. The frames 21 of the light-emitting diodes 20 are electrically welded to both sides of the through hole 11 of the circuit board 10 so as to enable the light-emitting diodes 20 to go across over the through hole 11 of the circuit board 10. In addition, each light-emitting diode 20 has a cup 23 inside the coupling base 22, and the bottom surface of the cup 23 is coupled with the circular heat-conducting layer 30 so as to outward dissipate the heat inside the light-emitting diode 20 by treating the heat-conducting layer 30 as a heat-conducting media. The heat-conducting layer 30 is practically a heat-sink plate or a heat-sink paste. In addition, the heat-sink block 40 that has several heat-sink fins is mounted underneath the heat-conducting layer 30. The heat-sink block 40 has a large heat-dissipating area for dissipating the heat quickly. The temperature of the light-emitting diodes 20 can be reduced rapidly since there is a very large contact area between the heat-sink block 40 and the air. The heat-sink block 40 is attached to the bottom of the heat-conducting layer 30 directly without separation by the circuit board 10 so the heat-dissipating efficiency of the light-emitting diodes 20 can be increased significantly.

In summary, the present invention indeed achieves the expected objects by disclosing a heat-sink module of light-emitting diode, wherein the circuit board has the through hole formed thereon so as to increase the heat-dissipating efficiency of the heat-sink module significantly. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A heat-sink module of light-emitting diode comprising:
a circuit board having a through hole formed thereon;
at least a light-emitting diode mounted across over said through hole of said circuit board;
at least a heat-conducting layer mounted under said light-emitting diode; and
a heat-sink block coupled with said heat-conducting layer via said through hole of said circuit board so as to increase the heat-dissipating efficiency of said light-emitting diode.

2. A heat-sink module of light-emitting diode of claim 1, wherein said heat-conducting layer is a heat-sink plate.

3. A heat-sink module of light-emitting diode of claim 1, wherein said heat-conducting layer is a heat-sink paste.
